(19) United States
(12) Patent Application Publication
(10) Pub. No.: US 2008/0193630 A1
(43) Pub. Date: Aug. 14, 2008

(54) Yuba

(75) Inventors: Eiji Kojima, Kanagawa (JP); Toshiaki Aoyama, Kanagawa (JP)

Correspondence Address: PROCOPIO, CORY, HARGREAVES & SAVITCH LLP, 530 B STREET, SUITE 2100, SAN DIEGO, CA, 92101, US

(73) Assignee: THE NISSHIN OILLIO GROUP, LTD., Chuo-Ku (JP)

(21) Appl. No.: 11/813,947

(22) PCT Filed: Jan. 12, 2006
(86) PCT No.: PCT/JP2006/300254

§ 371 Date: Jul. 13, 2007

(30) Foreign Application Priority Data
Jan. 17, 2005 (JP) 2005-009666
Jan. 12, 2006 (JP) PCT/JP2006/300254

(51) Int. Cl. A23L 1/28

(52) U.S. Cl. 426/655

(57) ABSTRACT

A bean curd skin having improved flavor and texture is provided by allowing the flavor and texture of the bean curd skin to be modified. An liquid bean extract including as a principal component a germinated bean extract derived from a germination-treated bean as a raw material is heated to obtain the bean curd skin. It is preferred that the germination-treated bean be germinated to an extent where the bitterness of the bean curd skin is reduced, and where the germination percentage of the germination-treated bean is 10% to 100%. The weight ratio of γ-aminobutyric acid to isoflavone in the liquid bean extract is more preferably in the range of 10 to 100 and 250 to 100. It is also preferred that the liquid bean extract further contains a common bean extract that is derived from a germination-untreated bean not subjected to germination treatment as a raw material.

### TECHNICAL FIELD

The present invention relates to a bean curd skin having superior nutritional quality and adjusted flavor, and more particularly, relates to a bean curd skin produced using a germination-treated bean having favorable flavor as a raw material, or using a raw material that includes a vegetable oil.

### BACKGROUND ART

With regard to processed foods of bean extracts (may be referred to as “soymilk”) typified by bean curd skin (may be referred to as “yuba”) and bean curd (may be referred to as “tofu”), due to the presence of a so-called “acrid taste” as a flavor derived from the raw material beans, reduction of the “acrid taste” thereof, and further improvement in flavor have been under investigation.

For example, Japanese Unexamined Patent Application Publication No. Hei 11-123060 discloses a soybean processed food produced using a germination-treated bean, as a soybean processed food in which the taste feature was significantly improved by increasing the content of amino acids such as glutamic acid, and sugar content such as sucrose or the like, accompanied by an improvement in the nutritional value. Examples of the soybean processed food include fermented soybean (may be referred to as “natto”), bean curd, bean extracts, boiled beans, or secondary processed foods.

Additionally, Japanese Unexamined Patent Application Publication No. 2003-93007 discloses a method of controlling germination of soybean by regulating the total amount of air bubbled so as to give a desired state of germination; a germination-treated bean obtained by the method; and a soybean processed food using the same. Soybean processed foods disclosed in the related arts include, fermented beans, boiled beans, bean extracts, bean curds and processed foods thereof.

### DISCLOSURE OF THE INVENTION

### Problems to be Solved by the Invention

Although bean curd was examined as the soybean processed foods in which the germination-treated bean was used in Japanese Unexamined Patent Application Publication No. Hei 11-123060 and Japanese Unexamined Patent Application Publication No. 2003-93007 described above, bean curd skin has not been examined in which germination-treated beans are used. Bean curd is produced using all of the bean extract as is, whereas bean curd skin is prepared using as a product only a thin membrane obtained by heating. As a result, in terms of the constituents, bean curd skin is characterized by a higher protein and lipid content, and lower carbohydrate content when compared with bean curd, and accordingly, both cannot be considered identical due to the differences in not only the form, but also the components. Hence, under the current circumstances, research into the improvement of the flavor of bean curd skin has not been conducted.

The present invention was made in view of the foregoing problems, and an object of the invention is to provide a bean curd skin having improved flavor and texture by modifying the flavor and texture of the bean curd skin.

### Means for Solving the Problems

In order to solve the foregoing problems, the present inventors thoroughly investigated, and consequently found that production of a bean curd skin using a bean subjected to a germination treatment as a raw material, or using a raw material including bean extract and a vegetable oil other than oils of bean extract raw material origin, can solve the aforementioned problems. Accordingly, the present invention was achieved. More specifically, the present invention provides the following.

The first aspect of the present invention comprises a bean curd skin obtained from a liquid bean extract including as a principal component a germinated bean extract derived from a germination-treated bean as a raw material.

According to the bean curd skin of the first aspect of the present invention, by merely using a germination-treated beans as raw material beans of the bean extract, the sense of acrid taste of the bean curd skin is reduced. In addition, the palatability is increased, and a taste similar to green soybean is imparted, whereby richness can be imparted to the bean curd skin. Accordingly, the flavor of the bean curd skin can be improved without adding other ingredients.

The second aspect of the invention is the bean curd skin according to the first aspect, wherein the germination-treated bean is germinated to an extent that the palatability of the bean curd skin is increased.

According to the second aspect, the palatability of the bean curd skin can be effectively increased, and the flavor can be more effectively improved. The phrase “extent that palatability of the bean curd skin is increased” refers to, for example, the case in which the category of “palatability” in a four-grade evaluation (see, Table 3) as in Test Example 1 of the sensory analysis of the Examples, as described later, was evaluated as being “a”, i.e., six or more among the ten panelists gave a grade of A to the bean curd skin of the germination-treated beans based on a control bean curd skin from germination-untreated beans (see, Table 4).

The third aspect of the invention is the bean curd skin according to the first or second aspect, wherein the percentage of the number of beans germinated to have a length of a sprout or root of 0.5 to 20 mm among the germination-treated beans is 70% to 100% of the total number of the beans actually germinated by way of the germination treatment.

According to the third aspect, substantially no astringency of the bean curd skin is present when the percent of beans having a length of the sprout or root of at least 0.5 mm is increased. In contrast, when the percent of germination-treated beans having a length of no more than 20 mm is increased, the palatability and sweetness of the bean curd skin are not significantly reduced.

The fourth aspect of the invention is the bean curd skin according to any one of the first to third aspects of the present invention, wherein the germination-treated bean is obtained by subjection to a treatment including the steps of: immersing the bean in water at 10° C. to 45° C. for 0.5 to 36 hours; and exposing the bean to a gas selected from the group consisting of air and oxygen, during or after the immersion step for 19 to 36 hours.

According to the fourth aspect, a germination-treated bean can readily be obtained having a germination percentage of the germination-treated bean of 10 to 100%, and having a weight ratio of γ-aminobutyric acid/isoflavone in the bean of 10/100 to 250/100. Therefore, bitterness and astringency can be reduced, whereby flavor of the bean curd skin can be efficaciously improved, and the overall palatability can be balanced.

The fifth aspect of the invention is the bean curd skin according to any one of the first to fourth aspects, wherein the weight ratio of γ-aminobutyric acid/isoflavone in an extract selected from the germinated bean extract and the liquid bean extract is 10/100 to 250/100.

According to the fifth aspect, by setting the weight ratio of γ-aminobutyric acid/isoflavone in the germinated bean extract or the liquid bean extract to be at least 10/100, bitterness and astringency of the bean curd skin can be reduced, while the overall palatability can be balanced by setting the weight ratio to be no more than 250/100.

The sixth aspect of the invention is a bean curd skin according to any one of the first to fifth aspects of the present invention, wherein the γ-aminobutyric acid content in 100 g of the solid content in an extract selected from the germinated bean extract and the liquid bean extract is 50 to 500 mg.

According to the sixth aspect, the nutritional quality of the bean curd skin is improved by increasing the γ-aminobutyric acid content, and the flavor of the bean curd skin can also be improved while maintaining a moderate balance in palatability.

The seventh aspect of the invention is the bean curd skin according to any one of the first to sixth aspects of the present invention, wherein the liquid bean extract further comprises a common bean extract that is derived from a germination-untreated bean as a raw material.

Conventionally, when a soybean cultivar with strong sweetness is used as a raw material, the thus obtained very sweet bean curd skin may lead to a heavy taste when dipped in soy sauce. However, according to the seventh aspect, by blending the germinated bean extract and common bean extract, the balance of palatability and sweetness of the bean curd skin can be adjusted.

The eighth aspect of the invention is the bean curd skin according to any one of the first to seventh aspects of the present invention, wherein the liquid bean extract further contains a vegetable oil other than oils of bean origin.

According to the eighth aspect, modification of the flavor and texture of the bean curd skin itself is possible by further including in the liquid bean extract the vegetable oil other than oils of bean origin. In particular, the sense of acrid taste is reduced, thereby providing a mild flavor. The modification of flavor herein indicates, for example, a reduction in acrid taste that is intrinsic to soybeans, an increase in the sweetness of soybeans, an increase in the richness of soybeans, and the like, while the modification of texture indicates an increase in smoothness and a creamy feel.

In addition, in the case of utilization of a bean curd skin of less moisture (for example, bean curd skin for processing), the processing may be facilitated because the membrane becomes soft.

Furthermore, in conventional bean curd skins, occurrence of contraction of the membrane itself is observed when the membrane is lifted; however, no substantial contraction occurs as a result of the inclusion of the vegetable oil, whereby the workability in the lifting is improved.

The ninth aspect of invention is the bean curd skin according to any one of the first to eighth aspects of the present invention, wherein the liquid bean extract further contains a vegetable oil other than oils of bean origin, in an amount effective for adjusting the flavor of the bean curd skin.

According to the ninth aspect, the flavor and texture of the bean curd skin itself can be modified by further including the vegetable oil in an amount effective for adjusting the flavor of the bean curd skin.

The tenth aspect of the invention is the bean curd skin according to the eighth or ninth aspect of the present invention, wherein the vegetable oil other than oils of bean origin is a cotton seed oil or olive oil.

In the foregoing, when cotton seed oil is used as the vegetable oil, the richness is enhanced as compared with the bean curd skin produced without vegetable oil, and the taste is balanced, accompanied by a fresh feel that results in distinct palatability. In addition, a soft texture is achieved, leading to a soft and pleasant taste. When olive oil is used as the vegetable oil, there is a moderate aftertaste when compared with the bean curd skin produced without olive oil, providing a well-balanced taste and fresh feel, the fresh feel resulting in distinct palatability. The cotton seed oil and the olive oil may be used in combination, and in this case, a synergistic effect of both oils improves the enhanced richness, desirable aftertaste, and fresh and balanced feel. Hence, the modification of the flavor and the texture may vary depending on the type or combination of the vegetable oil employed.

The eleventh aspect of the invention is a food comprising the bean curd skin according to any one of the first to tenth aspects of the present invention.

When a food including bean curd skin is a food originally lacking flavor, and when eating saltiness, spiciness, or pickled or salted vegetable or the like is desired, the disadvantage of desire for saltiness and the like cannot be avoided by merely including the bean curd skin derived from common bean extract into the food due to low richness and palatability of the bean curd skin.

In contrast, the food including the bean curd skin of the present invention is advantageous in that it can taste good without adding saltiness and the like, because the richness and palatability of the bean curd skin suitable for eating as-is can be provided. Hence, it is suggested that a surprising effect of possible use of the bean curd skin as a naturally derived seasoning, which provides a preferred taste, may be exhibited. Although the “food originally lacking flavor, and when eating saltiness, spiciness, or pickled or salted vegetable or the like is desired” is not particularly limited, and may be for example, porridge, steamed Chinese dumplings (shao mai), bean curd skin rolls, and the like.

The twelfth aspect of the invention is a bean curd skin obtained from a liquid bean extract including as a principal component a common bean extract that is derived from a germination-untreated bean as a raw material, and further comprises a vegetable oil in an amount effective for adjusting the flavor of the bean curd skin, the vegetable oil being a vegetable oil other than oils of bean origin.

According to another bean curd skin of the present invention, modification of flavor and texture of the bean curd skin is possible by further including a vegetable oil other than oils of bean origin in the liquid bean extract in an amount effective for adjusting the flavor of the bean curd skin. In particular, the sense of an acrid taste is reduced, and a mild flavor can be provided. The modification of flavor herein indicates, for example, a reduction in the acrid taste that is intrinsic to soybeans, an increase in the sweetness of the soybeans, an increase in the richness of soybeans, and the like, while the modification of texture indicates an increase in smoothness and a creamy feel.

In addition, in the case of utilization of bean curd skins of less moisture (for example, bean curd skin for processing), the processing can be facilitated because a soft membrane can be provided.

Furthermore, with conventional bean curd skins, the occurrence of contraction of the membrane itself is observed when the membrane is lifted; however, no substantial contraction occurs with the inclusion of the vegetable oil, whereby the workability in the lifting is improved.

The thirteenth aspect of the invention is bean curd skin according to the twelfth aspect, wherein the vegetable oil other than oils of bean origin is an oil selected from the group consisting of cotton seed oil or olive oil.

In the foregoing, when cotton seed oil is used as the vegetable oil, richness is enhanced as compared with the bean curd skin produced without cotton seed oil, and the taste is balanced, accompanied by a fresh feel to result in distinct palatability. Also, a soft texture is achieved, leading to softness and a pleasant taste. When olive oil is used as the vegetable oil, the flavor has a moderate aftertaste as compared with the bean curd skin produced without vegetable oil, providing a well-balanced taste and fresh feel, accompanied by a fresh feel to result in distinct palatability. The cotton seed oil and the olive oil may be used in combination, and in this case, a synergistic effect of both oils improves the enhanced richness, desirable aftertaste, fresh feel, and balanced feel. Thus, modification of the flavor and the texture may vary depending on the type or combination of the vegetable oils used.

### Effects of the Invention

Any one of the bean curd skins of the present invention, when compared with conventional bean curd skins produced using a common bean extract that is derived from a germination-nontreated bean as a raw material has at least: a good taste, increased sense of palatability involving richness, sweetness and the like; less sense of astringency involving a sense of an acrid taste, bitterness, and the like; and balanced palatability and astringency. Consequently, a flavor suited for enjoyable consumption is provided, and furthermore, preferable texture and appearance may also be achieved. Accordingly, the bean curd skin of the present invention is appetizing and suited for enjoyable consumption as compared with conventional bean curd skins. Therefore, according to the present invention, a bean curd skin having improved flavor, texture, and appearance can be provided.

### BRIEF DESCRIPTION OF THE DRAWINGS

FIG. 1 shows a graph illustrating the yield of each bean curd skin membrane of Example 4.

### PREFERRED MODE FOR CARRYING OUT THE INVENTION

### Definition of Type of Bean Curd Skin

Bean curd skins are generally obtained by heating a solution prepared by crushing a bean added to water, and removing a coagulated thin film formed on the surface of the liquid. The solution prepared by crushing a bean added to in water includes, for example, a bean extract produced from soybeans. The bean extract which can be used may be, for example, either a bean extract obtained after removing bean curd refuse, or a bean extract obtained by finely grinding the bean curd refuse. The bean curd skin contains a large amount of protein and lipids, and less carbohydrates when compared with raw material solutions (for example, bean extracts), having high calcium and iron content, and has high digestibility.

Bean curd skins are roughly classified into two types, i.e., fresh bean curd skins and dried bean curd skins depending on how the bean curd skins are dried (on the basis of differences in moisture content). Generally, the bean extract is heated in a bean extract bath, and the bean curd skin formed as a membrane is lifted with a spit, followed by drying the thereby obtained membrane. Fresh bean curd skins include bean curd skins subjected to the drying step to a slight extent (drawn bean curd skin, raw bean curd skin, and the like), and bean curd skins for processing produced by semi-drying to an extent that a food ingredient such as vegetables, and fish or animal meat can be wrapped thereby, while the dried bean curd skins include bean curd skins dried to have a moisture content of no more than 10%, so as to preserve the quality for a long period of time.

Although the designation may vary by the production area or manufactory, the fresh bean curd skins include “drawn (kumiage) bean curd skin” served and obtained by picking the bean curd skin immediately after formation of the membrane with chopsticks or fingers to directly eat, “raw (sashimi) bean curd skin” obtained by lifting the soft bean curd skin formed into a membrane with a spit so as not to be broken, or the like. Although a variety of names such as “raised (hikiage) bean curd skin”, “picked (tsumami) bean curd skin”, and the like have been used, there is no clear distinction. The fresh bean curd skin can be made into various cooked foods by boiling in a soup, and frying with oil to elevate the temperature of the processing. Bean curd skin rolls in soup is prepared by boiling the bean curd skin in soup to season and soften, whereby a preferred texture of bean curd skin, and a taste results from homogeneous softness, thereby imparting a characteristic feeling of dissolving in one's mouth.

The bean curd skin according to the present invention is intended not only to include the “drawn bean curd skin”, “raw bean curd skin”, “raised bean curd skin”, and “picked bean curd skin” described above, but all types of bean curd skins irrespective of the name.

Bean Curd Skin Derived from Germination-Treated Bean as Raw Material

The bean curd skin derived from a germination-treated bean as a raw material according to the first embodiment of the present invention is first explained in detail. The bean curd skin is obtained from a liquid bean extract (D) including as a principal component a germinated bean extract (A), which is derived from a germination-treated bean (a) as a raw material. Each component is explained in order below.

### a: Germination-Treated Bean

The germination-treated bean (a), which is a raw material of the germinated bean extract (A), is not particularly limited with respect to the type thereof, and may be for example, soybean, green soybean, kidney bean, adzuki bean, peanut, faba bean, garden pea, black bean, and the like. Among them, soybean is most preferably used in light of nutritional quality, processing adequacy, availability, and the like. Any one of domestic soybean, American soybean such as IOM, genetically modified soybean, or genetically unmodified soybean can be used as the soybean. When soybean is used as the bean, for example, the soybean subjected to a germination treatment may be herein referred to as “germination-treated soybean” and “germinated soybean”. The “germination-treated bean” according to the present invention indicates a bean exposed to an enhanced germination reaction by keeping dried beans at a constant temperature and humidity, regardless of the actual occurrence of germination.

a₁: Germination Percentage

The germination percentage of the germination-treated beans is not particularly limited, and is preferably 10% to 100%, more preferably 20% to 100%, and most preferably 30% to 95%. When the germination percentage is at least 10%, the γ-aminobutyric acid content per 100 g of the bean solid content becomes at least 50 mg, and the weight ratio of γ-aminobutyric acid/isoflavone in the bean can be maintained in a range of 10 to 100 and 250 to 100. Accordingly, bitterness, and astringency of the bean curd skin can be suppressed.

The germination percentage, referring to a proportion of the number of beans actually germinated among 100 beans, can be calculated by the following formula.

Germination Percentage (%)=Number of Germinated Beans/100 beans×100=Number of Germinated Beans

The term “germinated” in the calculation of the germination percentage refers to a state in which the sprout or root has emerged from the bean by breaking the skin. In other words, the number of germinated beans in the formula refers to the number of the beans which have actually germinated among 100 beans arbitrarily extracted from the beans subjected to the germination treatment.

a₂: Germination Method

The method of germinating the beans for obtaining the germination-treated beans described above is not particularly limited, and for example, a method can be illustrated which includes a gas contacting step of exposing the bean to air or oxygen for 19 to 36 hours, preferably 20 to 30 hours, and more preferably 20 to 24 hours, and which is carried out during or after the immersion step of immersing the beans in water at 10° C. to 45° C., preferably 20° C. to 45° C., and more preferably 30° C. to 42° C. for 0.5 to 36 hours, preferably for 1 to 10 hours, more preferably 1 to 5 hours.

When the treatment temperature in the immersion step is at least 10° C., the bean is likely to be germinated, while when the temperature is no more than 45° C., the germination percentage is not easily reduced. Additionally, when the water immersion time period is at least 0.5 hours, the bean is likely to be germinated, while when the time period is no more than 36 hours, no substantial putrefaction occurs, and excess water absorption, which may reduce the probability of germination, can be prevented, and furthermore elution of the nutritional components can be also suppressed.

When the time period of the gas contact step is at least 19 hours, germination is likely to occur while when the time period is no more than 36 hours, excess growth of the sprout or root can be prevented, thereby enabling the prevention of a reduction in palatability and sweetness, so as not to diminish the preferred taste.

When the gas contacting step is carried out following the immersion step, spraying of water or warm water, or immersion in water or warm water for a short period of time may be further conducted arbitrarily in the gas contacting step so as not to allow for further drying of the bean surface. In this case, the spraying or immersion may be carried out preferably at 2 to 12 hour intervals, and more preferably at 2 to 7 hour intervals. Moreover, the spraying or immersion may be carried out for a time period of preferably 1 to 30 min, more preferably 5 to 15 min each time.

In addition, when the gas contacting step is carried out during the immersion step, bubbling of air or oxygen in water or warm water is preferred because the germination can be promoted. In the case of performing the germination according to this method, satisfactory germination can be conducted without subjecting the bean to a treatment of exposure to air or oxygen after the immersion step as described above. In this case, the amount of air or oxygen bubbled is preferably 50 ml/min to 3000 ml/min per 100 g of bean before the immersion step, and the bubbling may be conducted either continuously or intermittently.

a₃: Weight Ratio of γ-Aminobutyric Acid/Isoflavone

γ-Aminobutyric acid is an amino acid which is widely distributed in the animal and plant kingdoms, and has palatability. In animals, this amino acid is present in the encephalon, and is a substance which is found to exhibit effects of enhancing blood flow to the brain, increasing the amount of oxygen supply to the brain, promoting the metabolic functions in a brain cells, reducing symptoms such as headaches due to sequelae of cerebral stroke, lowering blood pressure through acting on the vasomotor center of the medulla oblongata, and the like as a major inhibitory neurotransmitter.

Isoflavone refers to one, two, or more selected from daidzin, daidzein, genistin, genistein, glycitin, glycitein, acetyl daidzin, acetyl genistin, acetyl glycitin, malonyl daidzin, malonyl genistin, and malonyl glycitin, and was proven to exhibit a prophylactic effect on, in general, osteoporosis, climacteric disorder, and the like. However, because of its bitterness, it cannot be recognized as a preferable ingredient in terms of flavor.

The ratio of γ-aminobutyric acid/isoflavone in the germinated bean is not particularly limited, but the weight ratio of γ-aminobutyric acid/isoflavone in the germinated bean may be adjusted to preferably 10/100 to 250/100, more preferably 15/100 to 200/100, and most preferably 20/100 to 150/100, in order to control the balance of palatability and bitterness of the bean curd skin to where the flavor of the bean is improved. When this weight ratio of γ-aminobutyric acid/isoflavone is not less than 10/100, astringency and bitterness of the bean curd skin may be very weak, while when the ratio is not greater than 250/100, the overall palatability balance may be maintained without a predominant taste of γ-aminobutyric acid.

The ratio of γ-aminobutyric acid/isoflavone in the germinated bean extract or liquid bean extract is not particularly limited, but the weight ratio of γ-aminobutyric acid/isoflavone in the germinated bean extract or liquid bean extract may be adjusted to preferably 10/100 to 250/100, more preferably 15/100 to 200/100, and most preferably 20/100 to 150/100, in order to control the balance of palatability and bitterness of the bean curd skin to where the flavor of the bean is improved. When this weight ratio of γ-aminobutyric acid/isoflavone is not less than 10/100, astringency and bitterness of the bean curd skin may be very weak, while when the ratio is not greater than 250/100, the overall palatability balance may be maintained without a predominant taste of γ-aminobutyric acid.

Adjustment of the weight ratio of γ-aminobutyric acid/isoflavone in the germinated bean extract or liquid bean extract is carried out by germinating the bean. The weight ratio of γ-aminobutyric acid/isoflavone in the germinated bean extract or liquid bean extract can be calculated by the following formula.

Weight Ratio of γ-Aminobutyric Acid/Isoflavone in Germinated Bean Extract or Liquid bean extract=γ-aminobutyric acid content (mg) in 100 g of germinated bean extract or liquid bean extract/isoflavone content (mg) in 100 g of germinated bean extract or liquid bean extract

By substituting the “germinated bean extract or liquid bean extract” described above for “bean”, the γ-aminobutyric acid content (mg) per 100 g of the solid content of the bean can also be determined.

a₄: Analysis Method of γ-Aminobutyric Acid Content

Herein, the content of γ-aminobutyric acid (mg) in 100 g of beans can be determined by pulverizing about 1 to 10 g of the beans, thereafter charging the pulverized beans in a polar solvent such as methanol, ethanol, hydrous methanol, or hydrous ethanol, and homogenizing the mixture as needed, followed by heating the mixture as needed to about 80° C., and analyzing the filtrate obtained by filtration of the resultant liquid with an automated amino acid analyzer. Also, the content can be determined by pulverizing about 1 to 10 g of the bean, deproteinizing with a 10% by weight/volume sulfosalicylic acid solution or the like, adjusting the pH, and thereafter analyzing the filtrate obtained by filtration with an automated amino acid analyzer. Moreover, the γ-aminobutyric acid content (mg) in 100 g of the germinated bean extract or liquid bean extract can also be determined via the steps following the pulverization, as described above.

a₅: Analysis Method of Isoflavone Content Analysis

The isoflavone content (mg) in 100 g of the bean can be determined by pulverizing beans corresponding to 1 to 10 mg of soybean isoflavone, and thereafter charging the pulverized bean in a polar solvent such as methanol, ethanol, hydrous methanol, or hydrous ethanol, followed by homogenizing or extracting by heating to reflux the mixture as needed, and analyzing the filtrate obtained by filtration by way of an HPLC technique. Moreover, the isoflavone content (mg) in 100 g of the germinated bean extract or liquid bean extract can also be determined via the steps following the pulverization, as described above.

a₆: Length of Sprout or Root After Germination

Although the length of the sprout or root after germination is not particularly limited, in order to adjust the γ-aminobutyric acid content and the weight ratio of γ-aminobutyric acid/isoflavone in the germinated bean extract or liquid bean extract, the percentage of the number of beans having a length of the sprout or root being 0.5 to 20 mm among all of the germinated beans actually yielded by the germination is preferably 70% to 100%, more preferably 80% to 100%, and most preferably 90% to 100%. The percentage of beans having a length of the sprout or root falling within the range of 0.5 to 20 mm is preferred in terms of the following grounds. That is, the astringency of the bean curd skin substantially disappears when a high percentage of beans are included having a length of the sprout or root of at least 0.5 mm. In contrast, when a high percentage of beans are included having the length of no more than 20 mm, bean curd skin with an excellent taste can be obtained with substantially no reduction in palatability and sweetness of the bean curd skin.

The percentage of the number of the beans having a length of a sprout or root of 0.5 to 20 mm among the all of the beans actually germinated yielded by the germination can be determined by the following formula.

Percentage of Number of Beans Having a Length of Sprout or Root of 0.5 to 20 mm Among All of the Beans Actually Germinated Yielded by the Germination (%)=number of the beans having a length of the sprout or root of 0.5 to 20 mm/number of beans actually germinated out of 100 beans extracted from the germinated beans×100

Regulation of the length of the germinated sprout or root can be conducted by controlling the time period of exposure of the bean to air or oxygen after immersing the bean in water or warm water. As this time period of exposure to air or oxygen is increased, the length of the sprout or root is increased. In addition, when the germination is promoted through bubbling air or oxygen into the immersion of the beans, it can be regulated by the amount of air or oxygen bubbled. As the amount of bubbling is increased, the length of the sprout or root can be increased. For example, in the case of soybeans, when the germination is promoted under conditions of approximately 25° C. for 24 hours following the immersion, while freely spraying water, the germination percentage is about 65%, and the percentage of beans having a length of the sprout of 0.5 mm to 20 mm becomes about 100%.

a₇: γ-Aminobutyric Acid Content

Although the γ-aminobutyric acid content is not particularly limited, not only for increasing the γ-aminobutyric acid content to improve the nutritional quality, but for maintaining a moderate palatability balance to improve the flavor of the bean curd skin, the germination-treated bean has an γ-aminobutyric acid content per 100 g of the bean solid content of preferably 50 to 500 mg, more preferably 75 to 500 mg, and most preferably 100 to 500 mg. In addition, the γ-aminobutyric acid content (mg) per 100 g of the solid content in the germinated bean extract or liquid bean extract is preferably 50 to 500 mg, more preferably 75 to 500 mg, and most preferably 100 to 500 mg.

The term “bean solid content” herein refers to “solid content derived by subtracting the weight of water alone in the bean from the total weight of the bean”, and the term “content per 100 g of the bean solid content” refers to “content per 100 g of the solid content derived by subtracting the weight of water in the bean from the total weight of the bean”. Measurement of the weight of water in the bean can be conducted by, for example, a drying method under ordinary pressure (105° C., 5 hours). Therefore, the term “γ-aminobutyric acid content per 100 g of the bean solid content” refers to “γ-aminobutyric acid content included in 100 g of the solid content derived by subtracting the weight of water in the bean from the total weight of the bean (=bean solid content)”.

The γ-aminobutyric acid content per 100 g of the bean solid content (mg) is calculated by the following formula.

γ-Aminobutyric Acid Content (mg) in 100 g of Bean Solid Content=γ-aminobutyric acid content (mg) in 100 g of bean/percentage of bean solid content in the total weight of the bean (% by weight)×100

The γ-aminobutyric acid content (mg) in 100 g of the bean can be determined by the method explained above, and the percentage of the bean solid content (% by weight) in the total weight of bean can be determined by the following formula. The weight (g) of water in the bean in the formula can be measured by, for example, a drying method under ordinary pressure (105° C., 5 hours).

Percentage of Bean Solid Content in Total Weight of Bean (% by weight)=(total weight of bean (g)−weight of water in bean (g))/total weight of bean (g)×100

Furthermore, the γ-aminobutyric acid content (mg) per 100 g of the solid content in the germinated bean extract or liquid bean extract can also be measured by substituting the aforementioned “bean” for “germinated bean extract or liquid bean extract”.

The γ-aminobutyric acid content per 100 g of the solid content in the germinated bean extract or liquid bean extract can be adjusted to fall within the range described above by making the germination percentage fall within the range of preferably 10% to 100%, more preferably 20% to 100%, and most preferably 30% to 95%, and by germination to adjust the percentage of the number of beans having a length of sprout or root of 0.5 to 20 mm to fall within the range of preferably 70% to 100%, more preferably 80% to 100%, and most preferably 90% to 100% among all of the beans actually germinated.

### A: Germinated Bean Extract

The germinated bean extract (A) is a principal component of the liquid bean extract (D) of the present invention, and is produced by a conventionally known method using the germination-treated beans (a) described above. The bean extract generally refers to “a milky liquid prepared by mashing soybeans before solidifying into bean curd”, and also refers herein to “bean homogenate (may be referred to as ‘go’)” as well as soybean beverage and the like. Specifically, soybean is mashed to give a “bean homogenate”, which can be used following filtration thereof. The soybean solid content in the bean extract is generally at least 8%, and a bean extract having the soybean solid content of about 10% to 15% has been commonly used. In the present invention as well, the bean extract can be used having a soybean solid content falling within the above range. The germinated bean extract conceptually includes not only one type thereof, but two or more types may be included. Thus, the germinated bean extract of a single type or multiple types can be used. Furthermore, the term “principal component” indicates that the germinated bean extract (A) may be included in an amount of 100%, and other ingredients may be also included as long as the effect exhibited according to the present invention is not inhibited.

The bean curd skin produced from one type of the germinated bean extract described above has more palatability, less astringency, and a more well-balanced flavor than the bean curd skin produced from ungerminated bean extract; however, two or more types of the germinated bean extract can be used in combination. Accordingly, a balance of the bean curd skin such as palatability, sweetness, astringency and the like can be adjusted, whereby bean curd skin having an excellent taste and with a variety of tastes can be produced.

Blending with Common Bean Extract

The liquid bean extract (D) described above may further contain a common bean extract (B) derived from a germination-untreated bean (b) as a raw material.

### b: Germination-Untreated Beans

The germination-untreated bean (b) that is the raw material of the common bean extract (B) is not particularly limited with respect to the type thereof, and may be for example, soybean, green soybean, kidney bean, adzuki bean, peanut, faba bean, garden pea, black bean, and the like. Among them, soybean is most preferably used in light of nutritional quality, processing adequacy, availability, and the like. In addition, as the soybean, any one of a domestic soybean, American soybean such as IOM, genetically modified soybean, or genetically unmodified soybean can be used. When soybean is used as the bean, for example, the soybean not subjected to a germination treatment may be herein referred to as “germination-untreated soybean” and “ungerminated soybean”. The “germination-untreated bean” herein indicates a bean not subjected to the germination treatment described above.

### B: Common Bean Extract

By blending the common bean extract (B) with the germinated bean extract (A), the balance of richness and sweetness, the balance of palatability and astringency, and the overall flavor of the bean curd skin can be adjusted. The common bean extract (B) can be produced in a similar manner to that in the above (A) using the germination-untreated bean (b) described above by a conventionally known method. The soybean solid content in the bean extract is generally at least 8%, and a bean extract having a soybean solid content of about 10% to 15% has been commonly used. In the present invention as well, a bean extract can be used having a soybean solid content falling within this range. The common bean extract conceptually includes not only one type alone, but two or more types may be included. Thus, a common bean extract of a single type or multiple types can be used.

In this case, the blend ratio of the common bean extract (B) to the germinated bean extract (A) may vary depending on the type of the bean, and therefore cannot be unconditionally defined. However, in general, the ratio on the basis of the weight ratio is preferably from 0.01 to 100 per the germinated bean extract (A), and more preferably 0.1 to 10. For example, in the cases of Miyagishirome ungerminated bean extract and Ryuho germinated bean extract, the bean curd skin produced from a liquid bean extract including Miyagishirome ungerminated bean extract and Ryuho germinated bean extract with a weight ratio of 3 to 1 had more palatability and better taste as compared with the bean curd skin produced from Miyagishirome ungerminated bean extract alone, while exhibiting a balance of richness, distinct taste, sweetness, and had a better taste when compared with the bean curd skin produced from Ryuho germinated bean extract alone.

### C: Vegetable Oil

Vegetable oil may be added to the raw material of the bean curd skin of the present invention in order to adjust the flavor or texture. As the vegetable oil, a vegetable oil other than oils of bean origin is used. In this stage, approximately 3% by weight of soybean oil is already present in the bean extract. Therefore, the vegetable oil added in the present invention should be a vegetable oil other than the oil derived from the raw material of the bean extract.

In the present invention, the vegetable oil other than the oil derived from the raw material of the bean extract is not particularly limited, and is preferably oleic acid and linoleic acid-based fat and oil. Moreover, it is more preferred that the vegetable oil other than the oil derived from the raw material of the bean extract be cotton seed oil or olive oil.

The oleic acid and linoleic acid-based fat and oil is fat and oil having oleic acid and linoleic acid as principal components of the constitutive fatty acids, and both a non-drying oil containing a large amount of oleic acid and a semi-drying oil containing a large amount of linoleic acid can be used. Specifically, cotton seed oil and olive oil can be exemplified.

The vegetable oil described above may be added alone, or two or more may be used in combination. By using two or more kinds of vegetable oils in combination, the flavor can be further enhanced by a synergistic effect. Examples of such combination include, e.g., a combination of cotton seed oil and olive oil. In this case, the ratio of both oils used in combination preferably falls within the range of 1:99 to 99:1, and more preferably from 10:90 to 90:10 of cotton seed oil:olive oil on the basis of parts by weight.

The percentage of the added vegetable oil is not particularly limited, and is preferably an “amount effective for adjusting the flavor”. The “amount effective for adjusting the flavor” refers to the added amount required for exhibiting palatability that is distinct from the palatability of the bean curd skin to which no vegetable oil is added, through the addition of the vegetable oil. More specifically, the percentage of the vegetable oil is preferably 0.1% to 10% by weight, more preferably 0.5% to 3% by weight, and still more preferably 1% to 2.5% by weight of the entire liquid bean extract. When the percentage falls within the above range, a flavor with a variety of tastes can be added, and a favorable flavor and texture can be imparted.

The vegetable oil may be blended alone in the bean extract. In this case, when the vegetable oil is mixed with the bean extract, both components can be emulsified by applying a predetermined pressure. For example, an emulsion can be prepared by compression under a condition of 150 to 200 kg/cm² using a homogenizer.

Moreover, the vegetable oil may be included in the form of an emulsion that contains the vegetable oil. In this case, the emulsifying agent is not particularly limited, and known agents can be used such as polyglycerin fatty acid esters, lecithin, sucrose fatty acid esters, monoglycerin fatty acid esters, diglycerin fatty acid esters, organic acid monoglycerin fatty acid esters, sorbitan fatty acid esters, and the like. With respect to the amount of the emulsifying agent used, the weight ratio per the vegetable oil is preferably from 0.001 to 0.1 (i.e., from 0.1% by weight to 10% by weight). The emulsion described above includes principally, fat and oil, an aqueous solution (bean extract or the like), and an emulsion. This emulsion can be made by way of a procedure for commonly forming an emulsion in foods. The fat and oil is emulsified beforehand, and then the emulsion is mixed with the bean extract so as to predominantly facilitate the emulsification step. More specifically, when the bean extract, the fat and oil, and the emulsifying agent are mixed, and subjected to the emulsification treatment with a mixer or the like, a large quantity of foam is produced. Hence, the bean curd skin may not be successfully produced in some cases.

As the effect of the addition of the vegetable oil, an increase in yield of the bean curd skin, and an improvement in the formability of the membrane when lifting are found. In addition, an improvement of the formability of the membrane in lifting can make facilitate removing the bean curd skin from the surface of the liquid of the bean extract, and can produce a bean curd skin having a better appearance.

Bean Curd Skin Obtained from Liquid Bean Extract (D)

The bean curd skin of the present invention is obtained using the liquid bean extract (D) including the germinated bean extract (A) described above as a principal component.

The method of producing the bean curd skin is not particularly limited, and a conventionally known method can be employed. For example, the thin membrane generated on the surface of a heated bean extract may be lifted. The heating may be carried out by placement in hot water for heating, or in a microwave oven. The method of lifting the formed bean curd skin after heating also is not particularly limited. In addition, as a process other than heating, for example, a thin membrane may be formed by reducing the moisture with a treatment under a reduced pressure.

The thus resulting bean curd skin of the present invention is a bean curd skin obtained from a liquid bean extract including as a principal component a germinated bean extract that is derived from a germination-treated bean as a raw material. The germination-treated bean may be germinated to an extent that: astringency of the bean curd skin can be reduced; the balance of palatability and astringency of the bean curd skin is improved; better appearance of the bean curd skin is obtained; favorable texture of the bean curd skin is attained; or favorable palatability, astringency, appearance and texture of the bean curd skin (comprehensive evaluation of the bean curd skin) are attained, whereby the bean curd skin can be provided. Additionally, the method of producing the bean curd skin can be provided. Moreover, a method of adjusting the palatability of the bean curd skin (improvement method), a method of adjusting the astringency of the bean curd skin (reduction method), a method of adjusting the balance of the palatability and the astringency of the bean curd skin (improvement method), a method of adjusting the appearance of the bean curd skin (improvement method), a method of adjusting the texture of the bean curd skin (improvement method), a method of adjusting (improvement method) the palatability, astringency, palatability, appearance, texture of the bean curd skin (comprehensive evaluation of bean curd skin) can be provided. Thus, according to these aspects, a bean curd skin preferred for eating (compared to at least bean curd skins produced from common bean extract) can be provided or produced by the effect involved in respective bean curd skins, production methods, and adjustment methods.

The phrase “extent that the astringency of the bean curd skin can be reduced” refers to, for example, the extent of the case in which the category of “astringency” in a four-grade evaluation (see, Table 3), as in Test Example 1 of the sensory inspection of the Examples described later, is evaluated as being “a”, i.e., six or more among ten panelists gave a grade of A to the bean curd skin of the germination-treated bean based on the bean curd skin from germination-untreated bean as a control, or as being “b”, i.e., three to five panelists gave a grade of A (see, Example 1 in Table 4).

Moreover, the phrase “extent that balance of the palatability and the astringency of the bean curd skin is improved” refers to, for example, the extent that any of the categories of “palatability” and “astringency” in the four-grade evaluation (see, Table 3) in Test Example 1 is “b” or “a” (see, Example 1 in Table 4).

Furthermore, the phrase “extent that better appearance of the bean curd skin is obtained” refers to, for example, the extent that any of the category of “appearance (comprehensive)” in the four-grade evaluation (see, Table 3) in Test Example 1 is “b” or “a” (see, Example 1 in Table 4).

Moreover, the phrase “extent that favorable texture of the bean curd skin is attained” refers to, for example, the extent that the category of “texture” in the four-grade evaluation (see, Table 3) in Test Example 1 is “b” or “a” (see, Example 1 in Table 4).

In addition, the phrase “extent that favorable palatability, astringency, appearance and texture of the bean curd skin (comprehensive evaluation of the bean curd skin) are attained” refers to, for example, the extent that the item of “comprehensive evaluation” in the four-grade evaluation (see, Table 3) in Test Example 1 is “b” or “a” (see, Example 1 in Table 4), and is comprehensively tasty and appetizing.

Food Including Bean Curd Skin Obtained from Liquid Bean Extract (D)

The food of the present invention includes a bean curd skin obtained using the liquid bean extract (D) including as a principal component the germinated bean extract (A).

Although such a food is not particularly limited, examples thereof include, e.g., bean curd skin porridge, bean curd skin steamed Chinese dumplings, bean curd skin-rolled chicken, bean curd skin crackers, bean curd with bean curd skin, rolled bean curd skin (roll of bean curd skin alone), bean curd skin rolls (vegetable rolled or sandwiched with fresh bean curd skin), and the like. Furthermore, the method of the production of the food also is not limited, and a conventionally known method can be used.

The food including the bean curd skin acquires an excellent taste as compared with the food including the bean curd skin obtained from the common bean extract because richness and palatability of the bean curd skin are generated.

### Bean Curd Skin Produced Using Liquid Bean Extract Prepared By Adding Vegetable Oil to Common Bean Extract

Next, the present invention according to a second embodiment, which is a bean curd skin obtained using a liquid bean extract including a common bean extract and a vegetable oil added thereto, is explained. In this bean curd skin, the common bean extract (B) that is derived from the aforementioned germination-untreated bean (b) as a raw material is the principal component, and the bean curd skin is obtained by heating a liquid bean extract (E) further containing the vegetable oil (C).

The thus provided bean curd skin has a high degree of palatability and a favorable flavor such as mildness, and soft texture is attained as compared with the bean curd skin produced without adding the vegetable oil. Therefore, the flavor can be adjusted by adding the vegetable oil.

Moreover, by adding the vegetable oil to the common bean extract, an increase in the yield of the bean curd skin, and an improvement of the formability of the membrane in lifting are found. Additionally, by improving the formability of the membrane in lifting, the bean curd skin can be easily removed from the surface of the liquid of the bean extract. Therefore, a bean curd skin having much better appearance can be produced.

The percentage of the added vegetable oil is an “amount effective for adjusting the flavor”. The “amount effective for adjusting the flavor” refers to the added amount required for exhibiting palatability that is distinct from the palatability of the bean curd skin to which no vegetable oil is added, through the addition of the vegetable oil. More specifically, the percentage of the vegetable oil is preferably 0.1% to 10% by weight, more preferably 0.5% to 3% by weight, and still more preferably 1% to 2.5% by weight in the liquid bean extract as a whole. When the percentage falls within the above range, a flavor with a variety of tastes can be added, and a favorable flavor and texture can be achieved.

With respect to the type of the vegetable oil (C) and the method of producing the bean curd skin, since they are similar to those in the case in which the liquid bean extract (D) is used as described above, their explanation is omitted.

### EXAMPLES

Hereinafter, the present invention is explained in detail by way of Examples, but the present invention is not limited to these Examples. Unless particularly stated, “%” in the following Examples represents “% by weight”.

### Example 1

### (Preparation)

After immersing 30 kg of American IOM ungerminated soybean in 100 liters of warm water at 40° C. for 2 hours, germination was promoted for 24 hours in air while spraying water at 25° C. every 6 hours to obtain 69 kg of germination-treated soybean. The germination percentage in this state was 80%, and soybeans having a length of a sprout or root of 0.5 to 20 mm were 89% of the total number of the beans actually germinated by way of the germination. The thus resulting germination-treated soybeans in an amount of 60 kg were ground while adding water, and the bean curd refuse was separated to obtain a liquid. After heating the liquid with a direct steam blowing flash heater at 145° C. for 5 sec, the liquid was cooled to 5° C. to obtain a germinated bean extract. This germinated bean extract in a volume of 400 ml was charged in a stainless bean extract bath, which was placed into hot water for heating at a temperature of 80° C. When the temperature of the bean extract became 58° C., a first membrane was formed, which was lifted with a spit, and transferred onto a plastic wrap. Since the second membrane was formed 14 min later, it was lifted similarly with the spit, and overlaid on the first membrane. Thereafter, since the third membrane was formed 12 min later, and the fourth membrane was formed an additional 12 min later, the membranes were similarly lifted, and overlaid on the second membrane and the third membrane, respectively. Accordingly, the bean curd skin was obtained at a yield of 55 g (four membranes in total).

### (Analysis)

### Germinated Bean Extract

The thus resulting bean extract in an amount of 3 g was dried at 105° C. for 5 hours to determine the weight of water in the bean extract. The percentage of the solid content in the bean extract based on total weight of the bean extract was calculated from the measurement to give a value of 12% by weight. Furthermore, 3 g of the bean extract was stirred in a 10% by weight/volume sulfosalicylic acid solution, and the pH was adjusted. This solution was filtered, and the thus resulting filtrate was analyzed with an automated amino acid analyzer. As a result, the γ-aminobutyric acid content in 100 g of the bean extract was 30.0 mg. The γ-aminobutyric acid content in 100 g of the solid content of the bean extract was calculated from this analytical value to give the value of 250.0 mg. Then, 2 g of the bean extract was homogenized in hydrous methanol, methanol:water (weight ratio)=8:2, and after conducting heat reflux extraction for 1 hour twice, the filtrate obtained by filtration was subjected to an HPLC analysis. Consequently, the isoflavone content in 100 g of the bean extract was 48.4 mg. From these values, the weight ratio of γ-aminobutyric acid/isoflavone in the bean extract was determined to be 62/100.

TABLE 1

| | Membrane Formation | |
|---|---|---|
| | Time | Bean Extract Temperature |
| First | — | 58° C. |
| Membrane | | |
| Second | 14 min | 57° C. |
| Membrane | | |
| Third | 12 min | 56° C. |
| Membrane | | |
| Fourth | 12 min | 55° C. |
| Membrane | | |

| | |
|---|---|
| Yield (four membranes in total) | 55 g |

Table 1 shows the conditions of forming the bean curd skin membrane in Example 1. It is revealed that they were formed at substantially constant intervals and temperature.

### Example 2

The germinated bean extract was produced by a method similar to that of Example 1. 40 g of cotton seed oil was added to 60 g of the germinated bean extract, and the mixture was stirred at 10,000 rpm for 15 min with a homomixer (manufactured by Tokushurika K. K.) to obtain a homogenous emulsified fat and oil. The emulsified fat and oil in an amount of 20 g was added to 388 g of the germinated bean extract, and was briefly stirred so as to be homogenous, thereby yielding a germinated bean extract having added cotton seed oil. This germinated bean extract with cotton seed oil in a volume of 400 ml was charged into a stainless bean extract bath, and was placed in hot water for heating at a heating temperature of 80° C. When the temperature of the bean extract became 58° C., a first membrane was formed, which was lifted with a spit, and transferred onto a plastic wrap. Since the second membrane was formed 14 min later, it was lifted similarly with the spit, and overlaid on the first membrane. Thereafter, since the third membrane was formed 12 min later, and the fourth membrane was formed additionally 13 min later, the membranes were similarly lifted, and overlaid onto the second membrane and the third membrane, respectively. Accordingly, the bean curd skin with a yield of 59.5 g (four membranes in total) was obtained. The percentage of the vegetable oil added to the raw material was approximately 2%.

TABLE 2

| | Membrane Formation | Bean Extract |
|---|---|---|
| | Time | Temperature |
| First Membrane | — | 58° C. |
| Second Membrane | 14 min | 57° C. |
| Third Membrane | 12 min | 57° C. |
| Fourth Membrane | 13 min | 60° C. |

| | |
|---|---|
| Yield (four membranes in total) | 59.5 g |

Table 2 shows the conditions of forming the bean curd skin membrane in Example 2. It is revealed that the bean curd skin membranes of Example 2 were also formed at substantially constant intervals and temperature. Additionally, lifting of all the formed bean curd skin membranes was favorable as compared with the case in which no oil was added, and an increase in the yield of the bean curd skin was found.

### Example 3

The bean curd skin was produced by a similar method to Example 2, except that the cotton seed oil in Example 2 was replaced with olive oil, and the bean curd skin was obtained with a yield of 60.4 g (four membranes in total).

### Example 4

The germinated bean extract was produced by a similar method to Example 1. This germinated bean extract in a volume of 200 ml was charged into a polypropylene tray (trade name: Hotdeli 4, manufactured by FP Corporation), and subjected to a heat treatment in a microwave oven (power output: 500 W) for 3 min. The bean curd skin formed on the surface (first membrane) was lifted by overlaying the bean extract surface with a polypropylene membrane (thickness: 1 mm) having the same size as that of the formed bean curd skin. Subsequently, a heat treatment in the microwave oven was carried out for 1 min and 20 sec to form a bean curd skin (second membrane). This second membrane was lifted by overlaying the polypropylene membrane to which the first membrane was attached. Subsequently, a heat treatment in the microwave oven was carried out for 1 min to form the third membrane, which was lifted by a similar manipulation. Thereafter, the heat treatment for 1 min, and lifting of the bean curd skin were repeated seven times. Accordingly, the bean curd skins from a first to tenth membranes were produced. Accordingly, a bean curd skin with the total yield of 50.68 g was obtained.

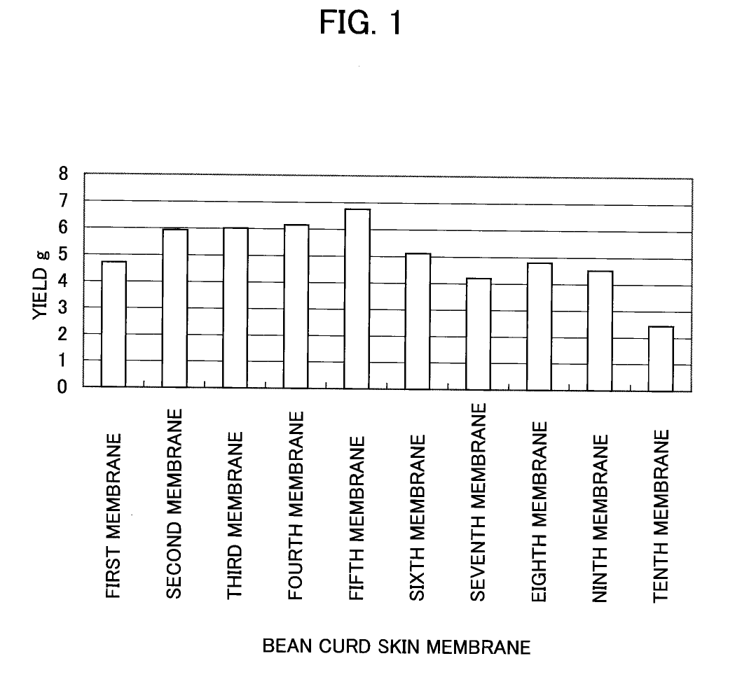

FIG. 1 shows the yield of each membrane in Example 4. Although the yield had decreased by the tenth membrane, the bean curd skin could be stably formed until the formation of the ninth membrane.

### Example 5

From 160 g of soybean cultivar “Miyagishirome” (sucrose content: 8.1%), the bean curd refuse was removed by compression using the fresh extraction method, and the liquid was subjected to a heat treatment (after heating at 90° C. for 5 min, cooling to 5° C.). The thus resulting bean extract (solid content: 12.8%) in an amount of 450 g was diluted with 50 g of water to obtain 500 g of 11.5% Miyagishirome bean extract (common bean extract). Soybean cultivar “Ryuho” (sucrose: 7.2%) in an amount of 160 g was immersed in 500 ml of water at 25° C. for 25 hours while aerating at 800 ml per min so as to spread over the soybean, whereby 300 g of the germination-treated soybean were obtained. The germination percentage in this state was 28%, and the soybeans having a root length of 0.5 to 20 mm was 98% of the total number of the beans actually germinated by way of the germination. To 250 g of the thus resulting germination-treated soybeans was added 500 ml of water, followed by grinding. Thereafter, the bean curd refuse was separated to obtain a liquid. After heating of the liquid at 90° C. for 5 min, the liquid was cooled to 5° C. to obtain 455 g of Ryuho germinated bean extract (solid content in the bean extract: 11.5%) (germinated bean extract). Then, 50 ml of Miyagishirome bean extract was combined with 150 ml of Ryuho germinated bean extract to make 200 ml, and the mixture was placed in a polypropylene tray (width: 180 mm×length: 200 mm×height: 30 mm), and was then subjected to a heat treatment in a microwave oven (power output: 500 W). The heating was stopped just before boiling, and the formed bean curd skin membrane was removed by attaching a polypropylene instrument for lifting the membrane (width: 100 mm×length: 170 mm×height: 20 mm) to the surface of the liquid bean extract. Thereafter, the same heating operation and manipulation of lifting the bean curd skin were repeated seven times, and about 40 g or more bean curd skin was thus obtained by superimposing the same instrument.

### Example 6

To 40 g of a vegetable oil (cotton seed oil) was added 0.4 g of an emulsifying agent (polyglycerin fatty acid ester, trade name: Sunsoft No. 818DG, manufactured by Taiyo Kagaku Corporation). After stirring briefly, 59.6 g of a bean extract (solid content: 15%, trade name: “Koi tonyu”, manufactured by Mamehiko Co.) was added thereto, and was stirred with a homomixer at 10,000 rpm for 15 min to give emulsified fat and oil. To 475 g of the bean extract (solid content: 15%, trade name: “Koi tonyu”, manufactured by Mamehiko Co.) was added 25 g of the emulsified fat and oil described above. After stirring briefly, the mixture was cooled to less than 10° C., whereby a bean extract was obtained with an added vegetable oil. The bean extract in a volume of 400 ml was charged into a stainless bean extract bath, which was put in hot water for heating at a temperature of 80° C. When the temperature of the bean extract became 60° C., a first membrane was formed, which was lifted with a spit, and transferred onto a plastic wrap. Since the second membrane was formed 15 min later, it was lifted similarly with the spit, and overlaid on the first membrane. Thereafter, since the third membrane was formed 14 min later, and the fourth membrane was formed an additional 14 min later, the membranes were similarly raised, and overlaid on the second membrane and the third membrane, respectively. Accordingly, the bean curd skin in a yield of 63 g (four membranes in total) was obtained. The percentage of the vegetable oil added to the raw material was approximately 2%.

The lifting of all of the formed bean curd skin membranes was favorable when compared to the case (Comparative Example 3) in which no oil was added, and an increase in the yield of the bean curd skin was found.

### Comparative Example 1

### (Preparation)

Using a bean extract produced from American IOM ungerminated soybean by a common method, a bean curd skin was obtained by a similar method to Example 1.

### (Analysis)

### Bean Extract

The following values were calculated by a similar method to Example 1 for the common bean extract that is derived from a germination-untreated soybean as a raw material. The percentage of the solid content in the bean extract based on the total weight of the common bean extract was 12% by weight. The γ-aminobutyric acid content in 100 g of the common bean extract was 0.7 mg. The γ-aminobutyric acid content in 100 g of the solid content of the common bean extract was calculated from this analytical value to give the value of 6 mg. The isoflavone content in 100 g of the common bean extract was 52.3 mg. From these values, the weight ratio of γ-aminobutyric acid/isoflavone in the common bean extract was determined to be 1.3/100.

### Comparative Example 2

Miyagishirome bean extract was produced by a similar method to Example 5. Using this Miyagishirome bean extract alone, at least 40 g of bean curd skin was obtained from 200 ml of the Miyagishirome bean extract by carrying out a similar procedure to Example 5.

### Example 7

Ryuho germinated bean extract was produced by a similar method to Example 5. Using this Ryuho germinated bean extract alone, at least 40 g of bean curd skin was obtained from 200 ml of the Ryuho germinated bean extract by carrying out a similar procedure to Example 5.

### Comparative Example 3

By a similar method to Example 6 except for the production without adding the vegetable oil and the emulsifying agent, 57 g of a bean curd skin was obtained.

### Example 8

Germinated bean extract (IOM) was produced by a similar method to Example 1. Using this germinated bean extract (IOM) alone, a bean curd skin was obtained by carrying out a similar procedure to Example 5. A soup (10 ml soup stock (trade name: Shiro-dashi, manufactured by NINBEN) to which 100 ml of water was added) in a volume of 110 ml was boiled, and the bean curd skin cut into a suitable size (3 cm×3 cm) was placed therein. After heating for 30 sec, the bean curd skin was turned upside down and heated for 30 sec. Thereafter, the bean curd skin was removed, and a thickened soup (prepared by boiling 110 ml of the soup in a pan, and approximately 0.4 ml of soy sauce and 5.5 g of potato starch powder were added thereto, followed by mixing quickly) was placed on the removed bean curd skin to obtain a bean curd skin roll with soup.

### Comparative Example 4

Using the bean extract alone produced from American IOM ungerminated soybean by a common method, a bean curd skin was obtained by carrying out a similar procedure to Example 5. Using this bean curd skin, a bean curd skin roll with soup was produced by a similar method to Example 8.

### Example 9

After immersing 300 g of American IOM ungerminated soybean in 900 ml of water at 10° C. for 10 hours, a plastic wrap hole punched to provide holes was overlaid to prevent drying at 20° C., and left to stand for 36 hours, yielding 690 g of a germination-treated soybean. The germination percentage in this state was 20%, and the soybeans having a length of a sprout or root of 0.5 to 20 mm were 100% of the total number of the beans actually germinated by way of the germination. After grinding 460 g of the thus resulting germination-treated soybeans to which 1000 ml of water was added, the bean curd refuse was separated to obtain a liquid. After heating the liquid at 90° C. for 5 min, the liquid was cooled to 5° C. to obtain 900 g of a germinated bean extract (solid content in the bean extract: 12.5%). Using this germinated bean extract, 54 g of a bean curd skin was obtained by a similar method to Example 1.

### Example 10

### (Preparation)

American IOM ungerminated soybean in an amount of 300 g was immersed in 900 ml of water at 25° C. while aerating at 1500 ml per min so as to expose all of the soybeans for 25 hours, whereby 690 g germination-treated soybeans were obtained. The germination percentage in this state was 30%, and the soybeans having a length of a sprout or root of 0.5 to 20 mm were 99% of the total number of the beans actually germinated by way of the germination. After grinding 460 g of the thus resulting germination-treated soybean to which 1000 ml of water was added, the bean curd refuse was separated to obtain a liquid. After heating the liquid at 90° C. for 5 min, the liquid was cooled to 5° C. to obtain 900 g of a germinated bean extract. Using this germinated bean extract, a bean curd skin was obtained by a similar method to Example 1.

### (Analysis)

### Germinated Bean Extract

The following values were calculated for the thus resulting germinated bean extract by a similar method to Example 1. The percentage of the solid content in the germinated bean extract based on the total weight of the germinated bean extract was 12% by weight. The γ-aminobutyric acid content in 100 g of the germinated bean extract was 22.7 mg. The γ-aminobutyric acid content in 100 g of the solid content of the germinated bean extract was calculated from this analytical value to give the value of 189.0 mg. The isoflavone content in 100 g of the germinated bean extract was 42.0 mg. From the above values, the weight ratio of γ-aminobutyric acid/isoflavone in the germinated bean extract was determined to be 54/100.

### Example 11

Porridge (retort pouch-packed food, trade name: Shiro-gayu, manufactured by Ajinomoto Co., Inc.) was placed in a rice bowl, and warmed in a microwave oven. The bean curd skin produced in Example 7 was cut into 1 cm square pieces, and approximately 30 g of the pieces were placed on the porridge. Following brief mixing, a bean curd skin porridge was obtained.

### Comparative Example 5

A bean curd skin porridge was obtained by carrying out a similar procedure to Example 11, except that the bean curd skin produced from the common bean extract produced in Comparative Example 2 was used.

### Test Example 1

### Difference in Flavors Between Germinated Bean Extract and Common Bean Extract

In order to compare the flavors of the bean curd skins produced using the bean extract derived from the germinated soybean and the common bean extract, the flavors of Example 1 and Comparative Example 1 were compared. In the evaluation, ten panelists observed and consumed 10 g of the bean curd skin, and graded the palatability, astringency, appearance, texture, comprehensive evaluation (comprehensive decision taking into consideration of flavor, appearance, and texture) according to the standards shown in Table 3, between four grades (A, B, C, D) to make an evaluation based on the following criteria (Evaluation was made by a similar method in the Test Examples set forth below). The bean curd skin for the evaluation was produced several times to obtain the amount required for the evaluation. The results are shown in Table 4.

a: six or more panelists gave grade A; and none gave grade D.
b: five or less panelists gave grade A; seven or more panelists gave either grade A or B; and none gave grade D.
c: cases other than “a”, “b” or “d”.
d: three or more panelists gave grade D.

TABLE 3

| Standard | A | B | C | D |
|---|---|---|---|---|
| Palatability | high | somewhat | medium | low, or not |
| | | high | | balanced |
| Astringency | weak, or | somewhat | medium | strong |
| | substantially | weak | | |
| | absent | | | |
| Appearance | preferable | somewhat | medium | Not |
| (Comprehensive) | | preferable | | preferable |
| Texture (Test | good melting- | soft | medium | hard |
| Examples 1 to 4) | in-mouth | | | |
| Texture (Test | preferable | somewhat | medium | rough |
| Example 5) | | preferable | | |
| Comprehensive | favorable | relatively | neither | relatively |
| evaluation | | favorable | | difavorable |

TABLE 4

| Evaluation | Example 1 | Comparative Example 1 |
|---|---|---|
| Palatability | a | c |
| Astringency | a | c |
| Appearance | a | c |
| (Comprehensive) | | |
| Appearance | whitish, light brown: | slightly brown: not |
| (color) | preferable | preferable |
| Appearance | moderate wrinkles: | many wrinkles, lean: |
| (wrinkle) | preferable | not preferable |
| Comprehensive | a | c |
| evaluation | | |

From the results shown in Table 4, the bean curd skin produced from the germinated bean extract exhibited higher palatability, and had better appearance when compared to the bean curd skin produced from the common bean extract.

### Test Example 2

### Difference in Flavors Caused by Adding Vegetable Oil to Germinated Bean Extract

In order to compare the flavors with or without addition of the vegetable oil to the germinated bean extract, the flavors of Examples 1 to 3, and Comparative Example 1 were compared. The results are shown in Table 5.

TABLE 5

| | | | | Com- |
|---|---|---|---|---|
| | | | | parative |
| Evaluation | Example 2 | Example 3 | Example 1 | Example 1 |
| Palatability | a | a | a | c |
| (evaluation) | | | | |
| Specific | Distinct | Distinct | | |
| palatability | palatability | palatability | | |
| | generated from | generated from | | |
| | Example 1; | Example 1; | | |
| | richness | flavor has | | |
| | enhanced, taste | moderate | | |
| | well-balanced, | aftertaste, | | |
| | and fresh | well-balanced, | | |
| | | and fresh | | |
| Astringency | a | a | a | c |
| Texture | b | b | c | c |
| Comprehensive | a | a | a | c |
| evaluation | | | | |

From the results shown in Table 5, the bean curd skin to which the vegetable oil was added exhibited soft texture, and had distinct palatability. Therefore, it was revealed that addition of a vegetable oil could adjust the flavor.

### Test Example 3

### Difference in Flavors Caused by Mixing of Germinated Bean Extract and Common Bean Extract

In order to compare the flavors of the bean curd skin produced from the bean extract prepared by mixing a germinated crude bean extract and a common bean extract, the flavors of Examples 5 and 7, and Comparative Example 2 were compared. The results are shown in Table 6.

TABLE 6

| Evaluation | Example 5 | Example 7 | Comparative Example 2 |
|---|---|---|---|
| Palatability | a | a | d |
| Specific | Distinct palatability | | Too sweet, inadequate |
| palatability | generated from Example 7. | | for eating with dipped |
| | Palatability increased with | | soy sauce due to not |
| | well-balanced richness and | | going well with soy |
| | sweetness. | | sauce. |
| Astringency | a | a | b |
| Specific | Similar to Example 7 overall. | | |
| astringency | Slightly less bitter compared | | |
| | to Example 7. | | |
| Comprehensive | a | a | c |
| evaluation | | | |

From the results shown in Table 6, by producing a bean curd skin through mixing the germinated bean extract with the common bean extract, a bean curd skin exhibiting well-balanced richness and sweetness, and a taste that is distinct from that of the bean curd skin produced from the germinated bean extract could be produced. This suggests that by producing the bean curd skin through mixing the raw material germinated bean extract with another bean extract, the flavor can be adjusted, and without use of food additives and seasonings, it is possible to adjust the flavor to meet the preference of a variety of consumers.

### Test Example 4

### Difference in Flavors Caused by Adding Vegetable Oil to Common Bean Extract

In order to compare the flavors with or without the addition of the vegetable oil to the common bean extract, the flavors of Example 6 and Comparative Example 3 were compared. The results are shown in Table 7.

TABLE 7

| Evaluation | Example 5 | Example 7 | Comparative Example 2 |
|---|---|---|---|
| Palatability | a | a | d |
| Specific | Distinct palatability | | Too sweet, inadequate |
| palatability | generated from Example 7. | | for eating with dipped |
| | Palatability increased with | | soy sauce due to not |
| | well-balanced richness and | | going well with soy |
| | sweetness. | | sauce. |
| Astringency | a | a | b |
| Specific | Similar to Example 7 overall. | | |
| astringency | Slightly less bitter compared | | |
| | to Example 7. | | |
| Comprehensive | a | a | c |
| evaluation | | | |

From the results shown in Table 7, the bean curd skin to which the vegetable oil was added exhibited a softer texture, and had less bitterness. Therefore, it was revealed that the addition of a vegetable oil could adjust the flavor.

### Test Example 5

### Difference in Flavors of Germinated Bean Extract and Common Bean Extract in Bean Curd Skin, Bean Curd Skin Roll with Soup

In order to compare the flavors of the bean curd skin and bean curd skin roll with soup produced using the common bean extract and the bean extract derived from the germinated soybean, the flavors of Example 8 and Comparative Example 4 were compared. The results of the bean curd skin are shown in Table 8, and the results of the bean curd skin roll with soup are shown in Table 9.

TABLE 8

| Evaluation | Example 8 | Comparative Example 4 |
|---|---|---|
| Palatability | a | c |
| Astringency | a | c |
| Appearance | a | c |
| (Comprehensive) | | |
| Appearance | whitish, light brown: | slightly brown: not |
| (color) | preferable | preferable |
| Appearance | moderate wrinkles: | many wrinkles, lean: |
| (wrinkle) | preferable | not preferable |
| Comprehensive | a | c |
| evaluation | | |

TABLE 9

| Evaluation | Example 8 | Comparative Example 4 |
|---|---|---|
| Palatability | a | c |
| Astringency | a | c |
| Appearance | a | c |
| (Comprehensive) | | |
| Appearance | bright and preferable | somewhat dark and dull |
| (color) | color tone | |
| Appearance | moderate wrinkles: | slightly many wrinkles, |
| (wrinkle) | preferable | lean: not preferable |
| Appearance (skin | glossy and good looking | |
| face) | | |
| Texture | A | d |
| Specific texture | | slightly rough and |
| | | unpleasant on the tongue |
| | | reflecting the state of |
| | | the wrinkles |
| Comprehensive | a | c |
| evaluation | | |

From the results shown in Table 8, the bean curd skin produced from the germinated bean extract exhibited stronger palatability, and had better appearance when compared to the bean curd skin produced from the common bean extract.

Additionally, from the results shown in Table 9, the bean curd skin roll with soup produced from the germinated bean extract exhibited stronger palatability, favorable texture, and was more preferable for consumption when compared to the bean curd skin roll with soup produced from the common bean extract. Moreover, the appearance of the bean curd skin roll with soup produced from the germinated bean extract exhibited a bright color tone, with moderate wrinkles, and was glossy.

### Test Example 6

### Difference in Flavors Between Germinated Bean Extract and Common Bean Extract

With regard to Example 9 and Comparative Example 1, flavors were compared by a similar method to Test Example 1. The results revealed that, similarly to Test Example 1, the bean curd skin of Example 9 produced from the germinated bean extract exhibited higher palatability, and had better appearance when compared to that in Comparative Example 1 produced from the common bean extract.

### Test Example 7

### Difference in Flavors Between Germinated Bean Extract and Common Bean Extract

With regard to Example 10 and Comparative Example 1, the flavors were compared by a similar method to Test Example 1. The results revealed that, similarly to Test Example 1, the bean curd skin of Example 10 produced from the germinated bean extract exhibited higher palatability, and had better appearance when compared to that in Comparative Example 1 produced from the common bean extract.

### Test Example 8

### Difference in Flavors Between Germinated Bean Extract and Common Bean Extract in Bean Curd Skin Porridge

In order to compare the flavors of bean curd skin porridge prepared with the bean curd skin produced using the common bean extract and the bean extract derived from the germinated soybean, a comparative sensory test was performed on Example 11 and Comparative Example 5.

For the evaluation, ten panelists tried 10 g of the bean curd skin porridge without knowing the identities of the samples, and selected the one that is more preferable to eat. Both test samples were compared in the foregoing criteria, and the evaluation was made from the decisions in the three categories below. The results are shown in Table 10.

(1) Example 11 is more preferable than Comparative Example 5.

(2) Comparative Example 5 is more preferable than Example 11.

(3) Decision cannot be made as to which one is more preferable.

TABLE 10

| | | | Not |
|---|---|---|---|
| | Example 11 | Comparative Example 5 | decided |
| Evaluation | 8 | 1 | 1 |
| Results | | | |
| (number of | | | |
| panelists) | | | |
| Specific | feel sweeter, with | light flavor, and plain; | |
| Evaluation | favorable flavor of bean; | modification of taste resulting | |
| | taste of added bean curd | from addition of the bean curd | |
| | skin can be ascertained; | skin cannot be realized; | |
| | good to eat without | saltiness, spices, pickled, | |
| | pickled or salted | salted vegetable or the like | |
| | vegetable because of the | would be desired when eating; | |
| | presence of palatability | taste stronger in Example 11, but | |
| | and richness | preference placed on Comparative | |
| | | Example 5 that is plainer | |

From the results shown in Table 10, the bean curd skin porridge prepared using the bean curd skin produced from the germinated bean extract had richness and palatability derived from the bean curd skin in the porridge as a whole as compared with the bean curd skin porridge prepared using the bean curd skin produced from the common bean extract. The bean curd skin porridge prepared using the bean curd skin produced from the germinated bean extract could be made to porridge suitable for consumption without the need of seasoning such as saltiness and the like, even though such porridges are usually bland and not edible plain. This suggests that the bean curd skin produced from the germinated bean extract exhibiting great richness and palatability has the surprising effect that it can be used as a seasoning.

1. A bean curd skin obtained from an liquid bean extract comprising as a principal component a germinated bean extract derived from a germination-treated bean as a raw material.

2. A bean curd skin according to claim 1, wherein the germination-treated bean is germinated to an extent that palatability of the bean curd skin is increased.

3. A bean curd skin according to claim 1, wherein the percentage of beans germinated having a sprout or root length of 0.5 to 20 mm among the germination-treated bean is 70% to 100% of the total number of the beans actually germinated by a germination treatment.

4. A bean curd skin according to claim 1, wherein the germination-treated bean is obtained by subjection to a treatment comprising the steps of:
immersing the bean in water at 10° C. to 45° C. for 0.5 to 36 hours; and
exposing the bean to a gas selected from the group consisting of air and oxygen, during or after the immersion step for 19 to 36 hours.

5. A bean curd skin according to claim 1, wherein the weight ratio of γ-aminobutyric acid to isoflavone in an extract selected from the germinated bean extract and the liquid bean extract is in the range of 10 to 100 and 250 to 100.

6. A bean curd skin according to claim 1, wherein the γ-aminobutyric acid content in 100 g of the solid content in an extract selected from the germinated bean extract and the liquid bean extract is 50 mg to 500 mg.

7. A bean curd skin according to claim 1, wherein the liquid bean extract further comprises a common bean extract derived from a germination-untreated bean as a raw material.

8. A bean curd skin according to claim 1, wherein the liquid bean extract further comprises a vegetable oil other than oils of bean origin.

9. A bean curd skin according to claim 1, wherein the liquid bean extract further comprises a vegetable oil in an amount effective for adjusting a flavor of the bean curd skin, and the vegetable oil is other than oils of bean origin.

10. A bean curd skin according to claim 8, wherein the vegetable oil other than oils of bean origin is an oil selected from the group consisting of cotton seed oil and olive oil.

11. A food comprising the bean curd skin according to claim 1.

12. A bean curd skin obtained from a liquid bean extract comprising as a principal component a common bean extract derived from a germination-untreated bean as a raw material, and further comprising a vegetable oil in an amount effective for adjusting a flavor of the bean curd skin,
the vegetable oil being a vegetable oil other than oils of bean origin.

13. A bean curd skin according to claim 12, wherein the vegetable oil other than oils of bean origin is an oil selected from the group consisting of cotton seed oil and olive oil.
